(19) United States
(12) Patent Application Publication
(10) Pub. No.: US 2004/0178880 A1
(43) Pub. Date: Sep. 16, 2004

(54) Secure cargo transport system

(76) Inventors: Michael Meyer, Vienna, VA (US); Yadunath Zambre, Mountain view, CA (US)

Correspondence Address: Michael Meyer, President, Utrue, Inc., 100 Shepherdson Lane, Vienna, VA, 22180, US

(21) Appl. No.: 10/387,522

(22) Filed: Mar. 14, 2003

(51) Int. Cl. H04Q 1/00; G05B 19/00

(52) U.S. Cl. 340/5.22; 340/5.3; 340/5.73

(57) ABSTRACT

A secure cargo transport system that prevents a mobile container from being compromised, lost, or contaminated during transit is disclosed. The cargo transport system contains both a lock and sensor(s) that lock and sense the environment surrounding the contents of cargo and/or of the cargo transport container. The lock and sensor(s) are in communication with a remote monitoring location where appropriate responses can be marshaled to breaches in cargo transport security or in the cargo environment.

### BACKGROUND OF THE INVENTION

1. Field of the Invention

The present invention is directed to a secure cargo transport system for transporting a container using a transportation vehicle such as, e.g., aircraft, trailer truck or ship. The cargo transport system prevents access to or operation of the container unless the container has been transported to a prescribed geographical location. The cargo transport system also alerts whether the contents of the container have been compromised or conversely whether the contents of the container could potentially compromise the contents of other nearby containers.

2. Background of the Invention

One of the most prevalent crimes plaguing the transportation industry is cargo theft. Worldwide industry theft losses for cargo theft in 1995 were approximately $470 billion, and an additional $400 billion was lost to various other fraudulent schemes. Hijackings and internal fraud costs to business have become so endemic, that the insurance industry has estimated that cargo theft losses now account for $150 of the retail price of every personal computer. As a consequence, insurance premiums and deductibles are rising at an alarming rate. Even though enforcement agencies have begun forming task forces to deal with the problem, most of their responses have been reactive rather than proactive; law enforcement and private industry have realized that they must work together to solve the problem.

In response, a very basic procedure to prevent theft has been to simply lock the doors of cargo containers and vehicles. These methods, however, have not provided adequate protection, as industry experts point out as much as 80% of cargo theft is the result of insiders with keys to the truck/carrier storage units. It has been concluded that the only way to secure cargo is to employ a measure that will assure that the transport vehicle or carried storage unit cannot be opened between its departure location and its intended destination.

U.S. Pat. No. 5,648,763 discloses a cargo container/vehicle with a geographical position detection unit (such as a Global Positioning System (GPS)-based unit) that is directly connected to the locking mechanism for the container and that prevents the container's locking system from being compromised/opened during transit.

A fundamental shortcoming of this approach is the fact that the security access control system and its associated geographical position detection equipment is directly linked with the hardware of the mechanical locking unit for the vehicle/cargo container doors at the rear of the truck. The fact that the two are directly linked through or along the confines of the truck where the cargo is stored, and the substantial physical separation there between creates the potential for damage or compromise of the control link between the security access control unit and the lock. In addition, all of the security access control information, including the critical geographical location information, is programmed into the security access control system. Since the security access control system is resident in equipment permanently installed in the container/vehicle, programming the geographical location information must be physically carried out “in the truck.”

U.S. Patent No. 6,384,709 (“the '709 patent”) and U.S. Published application No. 2001/0015691 (“the '691 application”) to Mellen et. al. disclose an access control system that prevents a container from being compromised during transit. The system uses a programmable electronic lock which can be unlocked only be means of an electronic key that has been programmed with geographical data representative of the destination site of the container. The '709 patent and the '691 application do not disclose real time monitoring to prevent tampering with the container.

U.S. Pat. No. 6,467,318 discloses a theft-resistant container which comprises a frame, a locking mechanism, and a cover member.

U.S. Pat. No. 6,366,242 discloses a geometry visualization tool for a geo-location system technician's computer that is operative to display a map of an asset management environment. The technician is able to interactively place and manipulate a distribution of tag transmission readers and any potential impairments to RF transmissions on the map.

U.S. Pub. app. No. 2003/0001775 discloses a system for locating an object using a plurality of tag signal readers that receive wireless tag signals from a tag transmitter coupled with an object to be located. The tag signals include data indicating the identity of the object to which the tag transmitter is coupled.

U.S. Pub. app. No. 2002/0181565 discloses a location system that includes a plurality of signal readers for receiving signals from a wireless transmitter to be located.

U.S. Pub. app. No. 2002/0118655 discloses a system that is operative for locating a wireless mobile device in communication with a wireless local area network (WLAN) that includes a plurality of cells defining a wireless local area network each having an access point base station.

U.S. Pub. app. No. 2002/0104879 discloses a system and method for identifying objects within a monitored environment and includes a plurality of tag signal readers contained within the monitored environment and serially connected along a single connection line as a coaxial cable for receiving tag signals from at least one tag contained within the monitored environment.

U.S. Pub. app. No. 2002/0094012 discloses an auxiliary wireless communication mechanism that is incorporated into a system that geolocates tagged objects within a monitored environment, using random, repetitive spread spectrum emissions from the tags.

U.S. Pat. No. 6,400,268 discloses a security structure intended particularly for the construction of security containers and security rooms. The security structure has an integral alarm mat. The alarm mat is constructed from one or more insulated, electrically conductive threads, wires or the like, or from one or more light conducting, optical fibers. The threads are disposed to form continuous meshes, loops, or eyes of the kind obtained when knitting or crocheting.

U.S. Pat. No. 6,289,457 discloses a value data system for secure electronic storage, transfer and other processing of value data using repositories of security controlled devices. The value data system includes a repository container including one or more of the repositories and a container security unit providing security signals as a function of conditions detected in the repository container.

U.S. Pat. No. 6,215,397 discloses a security structure intended particularly for the construction of security containers and security rooms. The security structure has an alarm mat integral therewith.

U.S. Pub. app. No. 2002/0051861 discloses a method of forming a cold detect on a substrate comprising the steps of applying an adhesive to a surface of a substrate and applying an intimate mixture of an indicator and a finely-divided moisture absorbent carrier to the adhesive-coated substrate to form a cold detect. The cold detect may be used as a closure adhesive to seal an adhesively-closable container, such as a security bag for bank notes or forensic evidence.

U.S. Pat. No. 5,337,588 discloses an electronic key and lock system, particularly useful for solenoid-operated locks, that employs a key that can operate electronically and mechanically.

U.S. Pat. No. 5,625,349 discloses a system for controllably actuating a lock mechanism that has a lock actuator control unit arranged to receive a key and to communicate with a programmable key control unit contained within the key.

As discussed above much of the theft in commercial transportation is performed by employees or others with authorized access to the hold in which the containers are stored for transport. In addition, there is also a need for a container that is capable of monitoring the environment in which it is stored. In order to insure the secure transport of cargo, the cargo transport container must be “smart” and capable of relaying sensor data to a remote location so that action can be directed to resolve any attempt to breach or compromise the contents of the container.

There is therefore a need for an improved secure cargo transport system that is capable of monitoring the integrity of the contents of the container and of the container itself.

### SUMMARY OF THE INVENTION

An object of the present invention is to provide a secure cargo transport system that is capable of tracking a cargo transport container in real time to the extent possible.

Another object of the present invention is to provide a secure cargo transport system where the container is able to communicate changes in environmental conditions.

Another object of the present invention is to provide a secure cargo transport system where the container is able to communicate unauthorized attempts to enter the container.

Yet another object of the present invention is to provide a secure cargo transport system where the attempts to enter the container can be visually recorded.

It is yet another object of the present invention to provide a secure cargo transport system that ensures the integrity of the contents of the container.

It is a further object of the present invention to provide a secure cargo transport system that ensures that the contents of the container will not affect its surroundings, including contents of surrounding containers.

Still another object of the present invention is to provide a secure cargo transport system where the container can be authorized for access through a remote network operations center.

It is yet another object of the present invention to provide a secure cargo transport system where the container can be accessed through biometric means.

In accordance with these objects, the present invention provides a secure cargo transport system wherein a network operations center is in wireless two-way communication with a cargo transport container. The container has an interior and exterior and may be manufactured to standard or custom dimensions based on the cargo to be transported. The container has a programmable lock that may be opened or unopened using a programmable key or by biometric means. In addition, the container may be optionally fitted with one or more sensors that are capable of detecting unauthorized attempts to access the container (tamper detection sensors) and/or report changes in environmental conditions (environmental condition sensors). The tamper detection sensors and the environmental sensors may be the same as or different from one another.

The sensors may be incorporated into a grid like structure integrated between the container interior and exterior. In a preferred embodiment, the container will have both tamper detection and environmental condition sensors that interface with the container exterior. The environmental condition sensors may use a variety of means to detect physical changes in the environment including but not limited to changes in temperature, humidity, and barometric pressure. The environmental condition sensors are also capable of detecting the presence of contraband on a molecular or atomic scale by using any one of a variety of analytical techniques including chromatography, mass spectroscopy, uv/vis spectroscopy, infra-red spectroscopy, magnetic resonance spectroscopy and chemical sensors.

The sensors and lock are in communication with a central control module or processor that is able to relay sensor and lock data to the network operations center. The present invention therefore provides a container that has an embedded secure cargo transport system. The container and the secure cargo transport system are tightly integrated so that the two are essentially indistinguishable. Any attempt to open the container and/or remove parts of the secure cargo transport system results in a breach that will cause the container to become dysfunctional. Breaches in the container or attempts to tamper with the container will cause the secure cargo transport system to issue alerts.

Typically, the central control module relays GPS, LORAN or other geo-location data, sensor data, and lock data through a cryptographic system before using an RF communication system, known in the art, to send and receive data from the network operations center. Sensor data can also be stored in memory before being relayed to the network operations center. For certain security situations, some sensor and location data with time stamps may be stored in encrypted form in non-volatile memory in order to retain a brief history. The data would be limited to that data which has not already been sent and where a loss or decrease of external power is detected. This data might be useful retrospectively or in real time should the power fluctuation be a result of external attempts to tamper with the system. The memory may be divided into volatile and nonvolatile memory. The data stored in volatile memory is typically sensor data that is time sensitive such as “heartbeat” or pulse data, environmental condition data, and container power status that may be communicated in periodic downloads to the network operations center. Non-volatile memory is stored on a more permanent basis and could include container signature data, key access data, and biometric data that enable access to the container. Non-volatile container data can be updated at anytime by transmission to the network operations center.

The container of the present invention is typically stored in the hold of a transport vehicle or a stack in a shipping or loading yard. Consequently, wireless transmissions between the container and the network operations center may not always be optimal. In a preferred embodiment, the vehicle hold will have a relay unit capable of transmitting signals between the container and the network operations center. In some cases, individual container communication systems serve as repeater units so that containers stored in the interior of a series of containers can remain in communication with network operations. Stated differently, the communications are relayed from the interior containers to a container having adequate wireless communication to the repeater or vehicle antenna before transmission to the network operations center.

The container of the present invention will optionally comprise a geographical position-based electronic lock and key system, using, for example, GPS, LORAN or some other geographical position system. Such systems utilizes a programmable electronic lock which can be unlocked only by means of a programmable electronic key, into which geographical location data of the destination site of interest has been programmed externally of the container, such as at a remote network operations center, and which remains disabled until it has been verified that the container has arrived at its destination site. It is also anticipated that the contents of the container may need to be attended to at locations intermediate of the destination and the point of origin. In these circumstances the key can be reprogrammed remotely from the network operations center using wireless technology to transmit authorization data to either the lock or the key.

When a key is inserted, the secure cargo transport system may remotely verify authorized access conditions and identities stored on the key. The system will then attempt to authorize access with the network operations center via a secure communication channel established with the container. The network operations center will allow or deny access, record the request, and if appropriate, initiate additional procedures.

Still another feature of the present invention allows keyless entry into the container whereby authorized access is confirmed through a biometric sensor. The biometric sensor can be designed to allow entry based on fingerprints, retinal eye-scans, face-recognition, etc. The lock can either have the comparative biometric data stored within the container or biometric profiles can be forwarded wirelessly to the container through the network operations center.

Biometric profiles may also be stored at the network operations center. And, analysis of whether the biometric signature attempting to access the container matches the authorized biometric profile may be done in a distributed manner, i.e., some part of the verification analysis is done at the container while the remainder is done at the network operations center.

Typically, once the container has arrived at its destination site, the programmable electronic key is inserted into a keyway unit, that is coupled to a geographical position detection system for the container. If the two sets of geographical location data match, the key becomes enabled for a prescribed interval of time (e.g., 5 minutes), which allows the key to operate the electronic lock and thereby provide access to the container. Providing such a time-limited enabling of the key prevents an operator from obtaining an enabled key at the authorized destination site and then transporting the container to an illegal location and opening and unloading the container at that point.

An additional feature of the present invention is that the locking system will periodically transmit location and environmental information to a network operations center whether the container is locked or unlocked. The notification messages will contain information such as the unique identifier for the key, identification information for the holder of the key, location and/or environmental constraints (conditions that must hold true/false to lock/unlock the container) that may be stored on the key. The notification messages provide an additional layer of security providing “real time” intrusion detection and a chronology of events surrounding the transport of cargo within the container.

In addition to the notification messages, the locking system also uses a distinct “heartbeat” message that periodically transmits signature electronic data and location and environmental information to the network operations center. This novel feature increases the level of monitoring and again provides information useful in “real time” detection of suspect activity as well as a retrospective analysis of theft or damage. Typically, the heartbeat will consist of signature, location and time data.

These aspects, advantages and other objects of the invention will be apparent to those of ordinary skill in the art from the following detailed description of the invention, particularly when considered in conjunction with the accompanying drawings, wherein like parts are depicted with like numerals.

### BRIEF DESCRIPTION OF THE DRAWINGS

FIG. 1 is a diagram illustrating the wireless relationship between the network operations center and the secure cargo transport container.

FIG. 2 is a two-dimensional diagram illustrating the relationship between the vehicle and the secure cargo transport container of the present invention.

FIG. 3 is a two-dimensional relationship drawing illustrating the hardware associated with the secure cargo transport container of the present invention.

FIG. 4 is a two-dimensional relationship drawing illustrating the hardware associated with the repeater device of the present invention.

FIG. 5A is a two-dimensional diagram illustrating a preferred embodiment of the spatial arrangement of the repeater, repeater internal antennae, and the vehicle antenna.

FIG. 5B is a two-dimensional diagram illustrating a second preferred embodiment of the spatial arrangement of the repeater, repeater internal antennae, and the vehicle antenna.

### DETAILED DESCRIPTION

The configuration of components and the manner in which they are interfaced with other secure cargo transport system equipment have, for the most part, been illustrated in the drawings by readily understandable block diagrams. These block diagrams show only those specific details that are pertinent to the present invention, so as not to obscure the disclosure with details which will be readily apparent to those skilled in the art having the benefit of the description herein. Thus, the block diagram illustrations are primarily intended to show the major components of the system in a convenient functional grouping, whereby the present invention may be more readily understood.

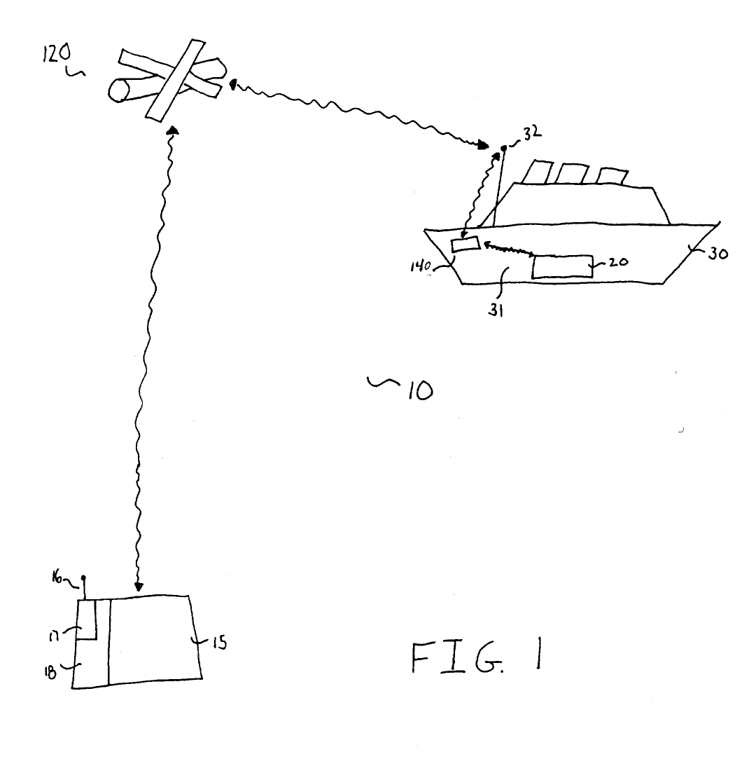

With reference now to the drawings, and in particular to FIGS. 1-3, a secure cargo transport system embodying the principles and concepts of the present invention and generally designated by the reference numeral 10 will be described.

More specifically, as shown in FIG. 1, the secure cargo transport system 10 comprises a network operations center 15 in wireless communication with a cargo transport container 20 housed within the hold 31 of a vehicle 30. Wireless communication may be carried out using a terrestrial tower (such as a cellular system), dedicated towers with landline connectivity, ocean relay buoys, or satellite 120 to relay communications between the network operations center 15 and cargo transport container 20. As shown in FIG. 1, the network operations center 15 has antenna or wireline connection 16 and is in wireless two-way communication with the cargo transport container 20. The network operations center 15 is typically located in a location remote to the cargo transport container 20, but can be on the vehicle 30 itself. The network operations center 15 is capable of tracking and managing multiple containers 20. It is also possible that multiple network operation centers 15 can work in tandem to maintain optimum wireless contact with the cargo transport container 20. In addition, the network operations center may be connected via a wire or wireless connection to third party communication system such as a cellular system backbone or infrastructure. The “antenna” would then be provided by the third party or system.

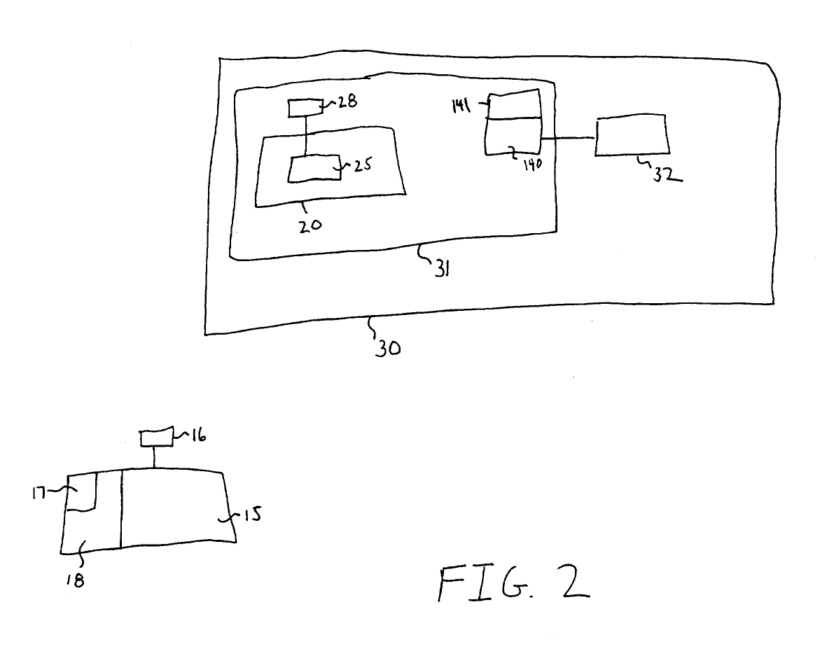

In a preferred embodiment, the secure cargo transport system 10 includes a geographical position detection system 45, such as, but not limited to a Global Positioning System (GPS)-based, LORAN-based, terrestrial, cellular, buoy based communication, or other equivalent navigation-geographical coordinate locating unit, to which a position location receiver 46 is coupled. The geographical position detection system 45, shown in FIG. 2, is preferably installed within the cargo transport container 20 so that it is physically attached to the cargo transport container 20, and therefore not subject to being removed or otherwise separated from the contents of the cargo transport container 20.

The position location receiver 46 is coupled to a central control module 40 that includes microprocessor, including digital and analog signal processing components. The central control module 40 relays geographic coordinate position data to a programmable electronic lock 25 that contains a keyway 22 configured to provide communication capability with a programmable key 23. The keyway 22 reads geographical position data provided in real time by the position location receiver 46, which is compared with geographical position data stored in memory of the programmable key 23. It is possible that the central control module will compare the geographical position provided by the key to keyway with the real time data from the GPS or similar system. The central control module would then allow or disallow the access. This allows for the key to be fully encrypted and the keyway to be fairly simple. The central command module would utilize the cryptographic module to encrypt or decrypt as needed. The keyway could be a fairly standard design except for an additional control interface that allows the central control module to control whether the keyway locks or unlocks in order to retrieve encrypted location data and the identification data for the key itself

Writing geographical location data into programmable key 23 is carried out using a further key programming interface 17 associated with digital terminal equipment located at network operations center 15, such as a point of origin supervisory dispatch center. Like the keyway 22 of the programmable lock 25 within the cargo transport container 20, the key programming interface 17 provides communication capability between the programmable key 23 and a control processor 18, through which a terminal operator may program prescribed access control information into programmable key 23 that has been inserted into the key programming interface 17.

At the network operations center 15, the dispatch operator may program one or more permission use parameters, and also enter geographical position data associated with the destination location of the cargo transport container 20, access to which is to be controlled by the programmable key 23. Once the cargo transport container 20 is closed and locked, it generally cannot be reopened until it has reached its destination location, and the programmable lock 25 on board the cargo transport container 20 has verified that the geographical position data from the position location receiver 46 at that location effectively corresponds to what has been programmed into the memory of the programmable key 23 at the network operations center 15. A novel feature of the present invention, however, allows the container lock instructions to be overridden at any point during cargo transfer. This feature is particularly useful when unscheduled stops require that the container be opened so that the contents can be tended to or so that government officials, such as customs agents, may inspect the contents of the cargo transport container 20. In such cases, the network operations center 15 can be notified and the operator, after confirming the necessity for gaining access to the cargo transport container 20, may wirelessly send overriding access instructions to the cargo transport container 20.

Geographical location-based enabling of the programmable key 23 may be optionally supplemented by one or more secondary parameters, such as date, user/driver identification, etc., that may be entered by an auxiliary input/output device, e.g., keypad 47 associated with the position location receiver 46.

Since the programmable lock 25 need only detect that the programmable key 23 has been enabled to operate the programmable lock 25, it does not need to be connected to any secondary site verification electronics, allowing the programmable lock 25 to be a stand-alone item that is physically isolated from the vehicle 30. This isolation and autonomous operation of the programmable lock 25 allows the lock's circuitry to be installed in a protected environment at the inside of an access door to the cargo transport container 20. It also allows the keyway 22 to be retained within a highly fortified housing 19 mounted to or mounted as a part of the exterior 24 of the cargo transport container 20, and which readily engages a door latching mechanism, such as a transportation industry standard J-hook latch.

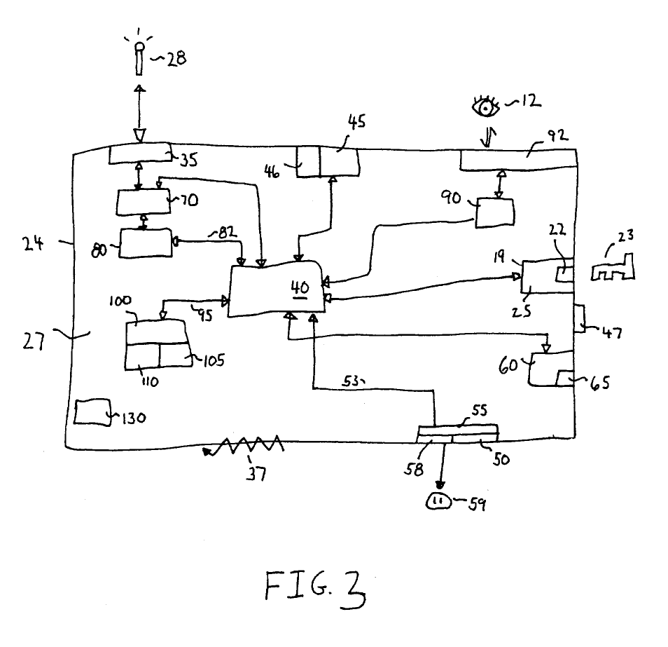

In a preferred embodiment, the programmable lock 25 is mounted on the interior 27 of the cargo transport container 20 and controls access to the cargo transport container 20. The programmable lock 25 can be opened or closed using the programmable key 23 as described above or, in the alternative, by supplying biometric data 12 to a biometric sensor interface 92 as best seen in FIG. 3. This feature allows keyless entry into the cargo transport container 20 where authorized access is confirmed through a biometric sensor 90. The biometric sensor 90 can be designed to allow entry based on fingerprints, retinal eye-scans, face-recognition, etc. Biometric sensor 90 includes those such as keypad 47 for entering access codes, fingerprint readers, and voice print sensors to verify the identity of individuals 12 with authorized access and to communicate unauthorized attempts to access the cargo transport container 20 back to the network operations center 15. The cargo transport container 20 will contain interfaces 92 for each biometric sensor 90. These interfaces 92 will not provide access to the internals of the cargo transport container 20. In a preferred embodiment, the various interfaces 92 are integrated into grid such that the tamper detection sensors 60 work synergistically with the biometric sensors 90 to detect any attempts to modify, replace, or remove any of the biometric sensors 90. The programmable lock 25 can either have the comparative biometric data stored within a memory module 100 within the cargo transport container 20, or biometric profiles can be forwarded wirelessly to the cargo transport container 20 through the network operations center 15. The latter technique is particularly useful when government officials request entry. In such cases, the biometric profile of government officials from a variety of unrelated agencies can be downloaded from a governmental database and forwarded to the cargo transport container 20 by the network operations center operator.

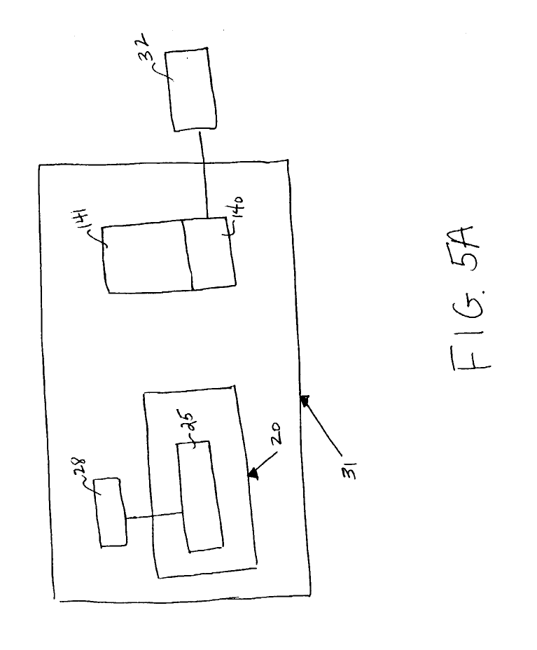

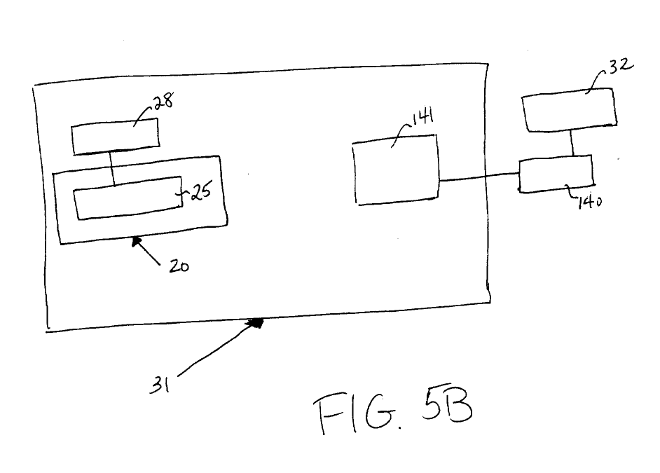

Antenna 28 on the cargo transport container 20 permits the lock 25 to communicate with an optional repeater device 29 or directly with the network operations programmable center 15. As shown in FIG. 5, the repeater device will take on two general embodiments. In FIG. 5A, the repeater 140 is located in the cargo hold 31. The internal antenna 141 is also inside of the hold 31 and may be separate or apart of the repeater enclosure. The external antenna 32 is mounted on the vehicle 30 at a location where there is good “RF visibility” to the network operations center 15. In FIG. 5B, both the internal antenna 141 and external antenna 32 are physically separate from the repeater 140. The repeater 140 is installed on the vehicle 30 at a location where access to power is available and convenient. It is also possible for the external antennae 32 and the repeater 140 to be integrated into the same enclosure without departing from the advantages illustrated in FIG. 5B.

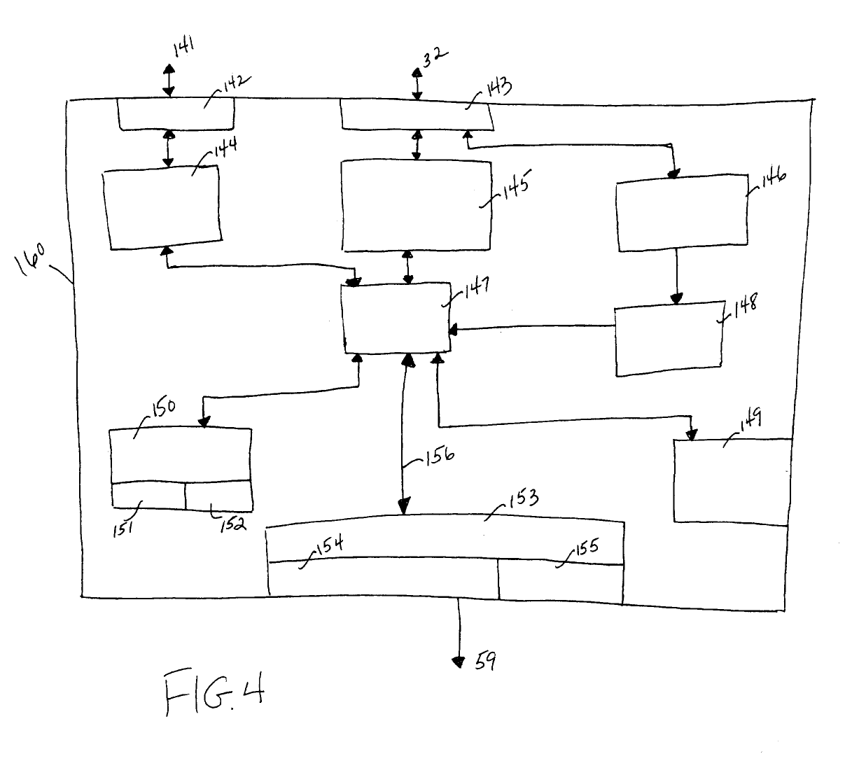

The repeater devices will have many of the capabilities and functionalities of the container's security/lock system. As illustrated in FIG. 4, all modules and systems in the repeater 140 are contained within a tamper-resistant enclosure 160. As with the cargo transport container 20, the repeater enclosure 160 is constructed with materials and mechanisms that resist unauthorized attempts to open, cut, or otherwise access the internals of the enclosure 160. Unlike the container 20, however, the repeater 140 will be sealed. No lock system or external access point will exist. The repeater 140 will have two antenna interfaces that allow the repeater 140 to be connected to additional antennae. These interface will not provide access to the internals of the repeater 140. Interface 142 is for connecting antenna 141 located on the interior of the vehicle 30 or on the interior of the cargo hold 20. Antenna interface 143 is for connecting antenna 32 to the repeater 140 and aids in establishing communication with the network operations center 15 and/or GPS, LORAN, or other external geolocation system components such as satellites 120, towers, buoys, etc.

As illustrated in FIG. 4, the repeater 140 will include a power management module 153 having a removable power source 155 such as a battery or fuel cell. The power management module 153 has external power interface 154 but does not provide access to the internals of the enclosure 160. The removable battery 155 will provide operating power to the repeater 140 when external power 59 is not available. During normal operations, the ship or vehicle 30 will provide power to the repeater 140. The battery or fuel cells 155 provide power when external power 59 is disengaged for any reason. It is anticipated that external power will be available to the repeater 140 on board all ships and trucks. Power management module 153 will detect the presence of external power 59. The power management module 153 will send signals 156 to the central control module 147 indicating the state of the battery 155 and the presence, absence, and quality of external power 59. A key security feature is that the repeater 140 will, using battery or fuel cell power 155, send an alert to the network operations center 15 whenever power is disengaged or whenever there are notable changes in power quality. The alert may include additional information deemed relevant by security professionals such as most recent repeater geophysical location.

The repeater 140 will include tamper detection sensors 149. While the repeater 140 is tamper resistant, the sensors 149 will signal the central control module 147 if and when the enclosure 160 has been opened or breached. The tamper detection sensors 149 will be fully contained by the tamper resistant enclosure 160. In some cases, the tamper resistant enclosure 160 may, itself, contain sensors that detect a breach. One of the tamper detection sensors may be a coating on the container enclosure 160 or walls that is activated by changes in environmental conditions such as light and temperature. An additional tamper detection sensor 149 may be a system that transmits electromagnetic and optical pulses through the walls and doors of the container 20. These sensors 149 will detect changes in the material, composition and structural integrity of the container walls and doors.

The repeater has two radio frequency communications modules 144, 145, one for communicating with cargo containers stored on the vehicle and one for communicating with the network operations center 15. Data or communications intended to travel between a cargo container 20 and the network operations center 15 are relayed through/by the internal communication system 144, central control module 147, and external communication systems 145 with no additional encryption. Data traveling between a cargo container 20 and the network operations center 15 is therefore not modified in any form within the repeater 140. The cargo container 20 and network operations center 15 each provide their own point-to-point or end-to-end encryption that secures their communications. The repeater 140 may optionally contain a cryptographic system 148. All communications intended to control the repeater 140 or that contain data about the repeater 140 will be encrypted. In dealing with information about the repeater 140, the repeater and network operations center 15 will communicate using a “private, encrypted channel” using different encryption keys from those used between any cargo container 20 and the network operations center 15. A central control module 147 will aggregate, analyze and manage all modules. In particular, the central control module 147 will store location and repeater status data in memory modules 150. Control module 147 will also transmit data (from memory) to the network control center 15 when connectivity is available (assumed to be the majority of the time). A memory system 150 will store data about the repeater 140. The memory module 150 will include volatile memory 152 (memory that is erased in the absence of power) and non-volatile memory 151 (memory that persists through the absence of power).

The cargo transport container 20 in its preferred embodiment is a self-contained unit where all components are contained within a tamper resistant enclosure. The cargo transport container 20 is constructed with materials that resist unauthorized attempts to open, cut, or otherwise access the contents of the cargo transport container 20. A standard low cost technique for tamper resistance is to encase the entire assembly in epoxy or some other similar material, which may contain a fibrous mesh that is difficult to cut or a material that is hard or contains hard particles thus making it hard to cut or penetrate. When using this technique, the cargo transport container 20 will have an antenna interface 35 as best seen in FIG. 2. The antenna interface 35 will not provide access to the interior 27 of the cargo transport container 20, but will simply serve as a socket in which the container antenna 28 can be inserted. In an even more preferred embodiment, the antenna interface 35 is not required, and the cargo transport container 20 itself or grid (not shown) including electronic circuitry encased between the exterior 24 and interior 27 of cargo transport container 20 serves as the container antenna 28. In one preferred embodiment, the container antenna 28 will be coated on the exterior surface 24 of the cargo transport container 20 in a manner similar to those used to construct strip-line transmission lines or strip-line antenna. In this embodiment, the cargo transport container 20 is completely closed to the outside environment.

The electronic circuitry that forms the grid is capable of transmitting and receiving a pulse 37. When the grid is altered through tamper or intrusion into the interior 27 of the cargo transport container 20, the interruption in the grid can be communicated by pulse 37 to the central control module 40 and to the communication system 70 and finally back to the network operations center 15.

The interior 27 of the cargo transport container includes a removable power source 50, such as a battery or a fuel cell, which is housed within a power management module 55. The removable power source 50 does not provide access to the interior 27 of the cargo transport container 20. A removable battery 50 provides operating power to the cargo transport container 20 when external power source 59 is not available. The power management module 55 has an external power interface 58 such as socket that allows the cargo transport container 20 to be connected to external power source 59 through a standard electric cable. Similar to the antenna interface 35, the external power interface 58 will not provide access to the interior 27 of the cargo transport container. The external power interface 58 will be used to provide power to the cargo transport container 20 when the cargo transport container 20 is stored in the hold 31. It is anticipated that external power source 59 will be available in some ports of call and possibly on board the vehicle 30. The external power interface 58 allows the cargo transport container 20 to minimize battery drain during operation and to recharge the removable battery 50 in many situations. The power management module 55 will detect the presence of external power and optimize battery life and use of available power. The power management module 55 is capable of communicating as depicted by arrow 53 to the central control module 40 to optimize the frequency and duration of data broadcasts when the state of the removable power source 50 and the presence or absence of external power source 59. The communication allows the central control module 40 to minimize the duration of data broadcasts when the cargo transport container 20 is operating solely on battery power during long cargo transport.

The cargo transport container 20 also includes tamper detection sensors 60. While the cargo transport container 20 is tamper resistant, the tamper detection sensors 60 signal to the central control module 40 if and when the enclosure has been opened or breached. The tamper detection sensors 60 will be fully enclosed by the cargo transport container 20. In a preferred embodiment, the tamper detection sensors 60 are coated on to the cargo transport container 20 and activated by changes in the physical integrity of the cargo transport container 20 such as unauthorized penetration into the interior 27 of the cargo transport container 20. Still a more preferred embodiment occurs when an electronic grid is employed to transmit electromagnetic and optical pulses through the walls and doors of the cargo transport container 20. The tamper detection sensors 60 essentially detect changes in the material composition and structural integrity of the cargo transport container 20. The mesh or grid thus serves as a circuit that conducts the pulse 37. The pulse 37 can include radio, optical, or acoustic pulses that probe the container 20 to determine if a material or structural change has occurred in the walls. In some instances the pulse 37 operates in a manner similar to seismographic measurements that are used to map features that are underground. Radio or optical, including X-ray, techniques may also be possible if the container 20 is constructed with suitable material.

The cargo transport container 20 may also utilize a radio frequency communication module such as a RF communication system 70 which is housed within the interior 27 of the cargo transport container 20. The RF communication system 70 serves to transmit data to the network operations center 15 and to receive data from both the network operations center 15. The RF communication system 70 is capable of routing data through a cryptographic system 80 which receives instructions 82 from the central control module 40. All communication to and from the network operations center 15 can therefore be encrypted.

In a preferred embodiment, the cargo transport container 20 may optionally contain a variety of environmental sensors 90. The environmental sensors 90, which are typically integrated with and/or maybe the same as the tamper detection sensors 60, may use a variety of means to detect physical changes in the environment including changes in temperature, humidity, and barometric pressure. The environmental sensors 90 are also capable of detecting the presence of contraband on a molecular or atomic scale by using any one of a variety of analytical techniques including chromatography, mass spectroscopy, uv/vis spectroscopy, infra-red spectroscopy, magnetic resonance spectroscopy, radiation detector and radiation spectroscopy such as alpha, beta, and/or gamma radiation spectroscopy, and chemical sensors.

In a still more preferred embodiment, the cargo transport container 20 may have a digital camera/video recorder 130 capable of transmitting or streaming video images of the person attempting to access the cargo transport container 20 to the network operations center 15 when an alert of container security is detected. Such a device serves as a secondary verification source and is particularly useful for alerting the network operations center 15 to circumstances when persons with authorized access are forced against their will to allow unauthorized persons access to the cargo transport container 20.

The central control module 40 is responsible for the aggregation, analysis and management of data from the various modules housed or integrated into the cargo transport container 20. One of the more important functions for the central control module 40 is the routing 95 of sensor data to and from memory 100. The central control module 40 will also transmit data from memory 100 to the network control center 15 when connectivity is available. This type of periodic “download” from the memory 100 to the network operations center 15 permits the reuse of memory 100 within the cargo transport container 20. In a preferred embodiment, the memory 100 will store sensor data into volatile memory 105 and non-volatile memory 110. The data stored in volatile memory 105 is typically sensor data that is time sensitive such as heartbeat pulse data, environmental condition data, and container power status that may be communicated in periodic downloads with the network operations center 15. Non-volatile memory 110 is stored on a more permanent basis and could include container signature data, key access data, and biometric data that enables access to the cargo transport container 20. Non-volatile container data can be updated at anytime by transmission between the network operations center 15.

The preceding description is exemplary rather than limiting in nature. Variations and modifications to the disclosed examples may become apparent to those skilled in the art that do not necessarily depart from the purview and spirit of the invention.

What is claimed is:

1. A secure cargo transport system comprising:
(a) a network operations center;
(b) a container having an interior and an exterior, said container further comprising;
(i) a lock;
(ii) one or more sensors; and
(c) a key for opening or closing the container lock.

2. The secure cargo transport system of claim 1 wherein said container further comprises an RF communication system for providing communication between the container and the network operations center.

3. The secure cargo transport system of claim 2 having a cryptographic system.

4. The secure cargo transport system of claim 1 wherein said container further comprises a memory system.

5. The secure cargo transport system of claim 1 further comprising a signal repeater device.

6. The secure cargo transport system of claim 5 wherein the repeater has an encryption system.

7. The secure cargo transport system of claim 5 wherein the repeater has a geographic position detection system.

8. The secure cargo transport system of claim 5 wherein the repeater has a first radio frequency communications module for communicating with additional cargo containers and a second radio frequency communications module for communicating with the network operations center.

9. The secure cargo transport system of claim 1 wherein said sensors are integrated as a grid between the interior and exterior of the container.

10. The secure cargo transport system of claim 1 wherein the key is programmable.

11. The secure cargo transport system of claim 10 wherein said key is programmed through said network operations center.

12. The secure cargo transport system of claim 1 wherein the container is accessed through biometric means.

13. The secure cargo transport system of claim 1 wherein said sensors contain at least one biometric and one tamper detection sensor.

14. The secure cargo transport system of claim 1 wherein said sensor may detect by means selected from the group consisting of chromatography, mass spectroscopy, uv/vis spectroscopy, ir spectroscopy, magnetic resonance spectroscopy, biometrics, and chemical sensors.

15. The secure cargo transport system of claim 1 wherein the container includes a geographical position detection subsystem.

16. The secure cargo transport system of claim 15 wherein said geographical position detection subsystem is a Global Positioning System (GPS).

17. The secure cargo transport system of claim 15 wherein said geographical position detection subsystem is LORAN based navigation.

18. The secure cargo transport system of claim 1 wherein the sensor further comprises a camera actuated by changes in lock or sensor status.

19. A secure cargo transport container in communication with a network operations center comprising:
(a) a container having an interior and an exterior;
(b) a lock;
(c) one or more sensors, wherein said one or more sensors detect an environmental condition of the container.

20. The secure cargo transport container of claim 19 further comprising a signal repeater device.

21. The secure cargo transport container of claim 20 wherein the repeater has an encryption system.

22. The secure cargo transport container of claim 20 wherein the repeater has a geographic position detection system.

23. The secure cargo transport container of claim 20 wherein the repeater has a first radio frequency communications module for communicating with additional cargo containers and a second radio frequency communications module for communicating with the network operations center.

24. The secure cargo transport container of claim 19 wherein said one or more sensors may detect by means selected from the group consisting of chromatography, mass spectroscopy, uv/vis spectroscopy, it spectroscopy, magnetic resonance spectroscopy, chemical sensors.

25. The secure cargo transport container of claim 19 wherein the sensor includes a geographical position detection subsystem.

26. The secure cargo transport container of claim 25 wherein said geographical position detection subsystem is a Global Positioning System (GPS).

27. The secure cargo transport container of claim 25 wherein said geographical position detection subsystem is LORAN based navigation.

28. The secure cargo transport container of claim 19 wherein the container further comprises a camera actuated by changes in container status.

29. The secure cargo transport container of claim 19 wherein said container is accessed by biometric means.

30. A process for transporting cargo comprising locking said cargo in a cargo transport container as claimed in claim 19 and transporting the cargo from a first location to a second location.

31. The process of claim 30 wherein a signal repeater device is located between the lock and the network operations center.

32. The secure cargo transport system of claim 31 wherein the repeater has an encryption system.

33. The secure cargo transport system of claim 31 wherein the repeater has a geographic position detection system.

34. The secure cargo transport system of claim 31 wherein the repeater has two radio frequency communications modules, one for communicating with additional cargo containers and one for communicating with the network operations center.

35. The process of claim 30 wherein the sensor may detect by means selected from the group consisting of chromatography, mass spectroscopy, uv/vis spectroscopy, ir spectroscopy, magnetic resonance spectroscopy, chemical sensors.

36. The process of claim 30 wherein said sensor includes a geographical position detection subsystem.

37. The process of claim 36 wherein said geographical position detection subsystem is a Global Positioning System (GPS).

38. The process of claim 36 wherein said geographical position detection subsystem is LORAN based navigation.

39. The process of claim 30 wherein the container further comprises a camera actuated by changes in the lock status.

40. The process of claim 30 wherein said container lock is accessed by biometric means.

41. A method for secure cargo transport comprising:
(a) monitoring a location of said cargo; and
(b) monitoring integrity of said cargo.
